(19) United States
(12) Patent Application Publication
(10) Pub. No.: US 2026/0359166 A1
(43) Pub. Date: Nov. 12, 2026

(54) FUNCTION APPLICABILITY FOR DETERMINATION OF SUPPORTED COMMANDS IN A MEMORY SYSTEM

(71) Applicant: Micron Technology, Inc., Boise, ID (US)

(72) Inventors: Marco Sforzin, Cernusco Sul Naviglio (MI) (IT); Su Wei Lim, Penang (MY)

(21) Appl. No.: 19/659,890

(22) Filed: Apr. 27, 2026

Related U.S. Application Data
(60) Provisional application No. 63/801,580, filed on May 7, 2025.

(51) Int. Cl. G06F 11/10

(52) U.S. Cl. CPC G06F 11/1068; G06F 11/1048

(57) ABSTRACT

Methods, systems, and devices for data correction switching in multi-die memory systems are described. A memory system may be configured to enter a reduced accessibility mode while correcting an error in a group of memory dies. In some examples, the memory system may transmit an indication that the memory system enters the reduced accessibility mode in response to detecting an error in the group of memory dies. The reduced accessibility mode may indicate that one or more data buses associated with the group of memory dies are inaccessible by the host system. In some examples, while operating in the reduced accessibility mode, the memory system may reconstruct user data from a memory die including the error and transfer the reconstructed user data to a replacement memory die of the group.

### CROSS REFERENCE

The present Application for Patent claims priority to U.S. Patent Application No. 63/801,580 by Sforzin et al., entitled “DATA CORRECTION SWITCHING IN MULTI-DIE MEMORY SYSTEMS,” filed May 07, 2025, which is assigned to the assignee hereof, and which is expressly incorporated by reference in its entirety herein.

### TECHNICAL FIELD

The following relates to one or more systems for memory, including data correction switching in multi-die memory systems.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports data correction switching in multi-die memory systems in accordance with examples as disclosed herein.

FIG. 2 shows an example of a memory system that supports data correction switching in multi-die memory systems in accordance with examples as disclosed herein.

FIG. 3 shows an example of a process that supports data correction switching in multi-die memory systems in accordance with examples as disclosed herein.

FIG. 4 shows a block diagram of a memory system that supports data correction switching in multi-die memory systems in accordance with examples as disclosed herein.

FIGS. 5 and 6 show flowcharts illustrating a method or methods that support data correction switching in multi-die memory systems in accordance with examples as disclosed herein.

### DETAILED DESCRIPTION

Memory systems may be provided in accordance with various configurations for storing and maintaining information in one or more memory arrays. For example, a memory system may include one or more memory dies (e.g., each including one or more arrays of memory cells) configured to store information, such as user data. In some examples, a memory system may support error control operations to detect and correct errors in data. The memory system may store error correction information (e.g., parity information, error correction bits, cyclic redundancy check (CRC) bits) to support correction of detected errors. In some implementations, parity information may be configured to support error correction for multiple memory dies. For example, a memory system may include a group of memory dies (e.g., a “data stripe”), for which a set of first memory dies of the group may store user data and one or more second memory dies of the group may store parity information for correcting errors detected in user data stored to one or more of the first memory dies. In some examples, correcting an error may include the memory system performing an operation (e.g., a read-modify-write operation) to read user data from a portion of a die that includes the error, reconstructing the user data in accordance with the parity information, and writing the reconstructed user data to an available (e.g., replacement) die of the group of memory dies. However, while performing such an operation to correct an error, the memory system may be susceptible to additional errors in the user data, which may be uncorrectable errors (e.g., errors unable to be corrected using the stored parity information). For example, the memory system may receive one or more access commands indicating to access (e.g., read or write) data in the group of memory dies, which may result in the additional errors, thereby limiting an ability of the memory system to store and maintain information in the group of memory dies.

Techniques described herein provide for a memory system to enter a reduced accessibility mode while correcting an error in a group of memory dies. In some examples, the memory system may transmit an indication (e.g., to a host system) that the memory system enters the reduced accessibility mode in response to detecting an error in the group of memory dies. The reduced accessibility mode may indicate that one or more data buses associated with the group of memory dies are inaccessible by the host system. For example, the data bus(es) may be configured to transfer information between the group of memory dies and a queue (e.g., a queue for the host system to input access data), and, while operating in the reduced accessibility mode, the memory system may inhibit the data bus(es) from transferring information between the group of memory dies and the queue. In some examples, the reduced accessibility mode may be applicable to the group of memory dies and one or more second groups of memory dies that share the data bus(es) with the group of memory dies (e.g., other ranks or groups of memory dies). In some such examples, the reduced accessibility mode may not be applicable to one or more third groups of memory dies that do not share the data bus(es) with the group of memory dies (e.g., one or more groups of memory dies may continue to operating in accordance with a baseline operating mode while another one or more groups of memory dies operate in accordance with the reduced accessibility mode). Such techniques may prevent additional (e.g., uncorrectable) errors from being experienced among the group of memory dies due to the host system attempting to access data in the group of memory dies while the memory system corrects an error in the group of memory dies. Further, by supporting baseline operations at the one or more third groups of memory dies, the memory system may mitigate adverse effects (e.g., access latency) associated with operating in the reduced accessibility mode. In some implementations, such techniques may be implemented to support single-device data correction (SDDC) techniques (e.g., error correction for a single die) for correcting errors of multiple dies (e.g., at different times), providing at least some of the advantages of dual-device data correction (DDDC) techniques, but with reduced parity and die allocations (e.g., blending aspects of SDDC and DDDC techniques).

In addition to applicability in memory systems as described herein, techniques for data correction switching may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by reducing a likelihood of uncorrectable errors at the electronic devices, which may mitigate failures at the electronic devices, support subsequent operations by the electronic devices, or otherwise improve user experience, among other benefits.

Features of the disclosure are illustrated and described in the context of systems, devices, and circuits. Features of the disclosure are further illustrated and described in the context of memory systems, processes, and flowcharts.

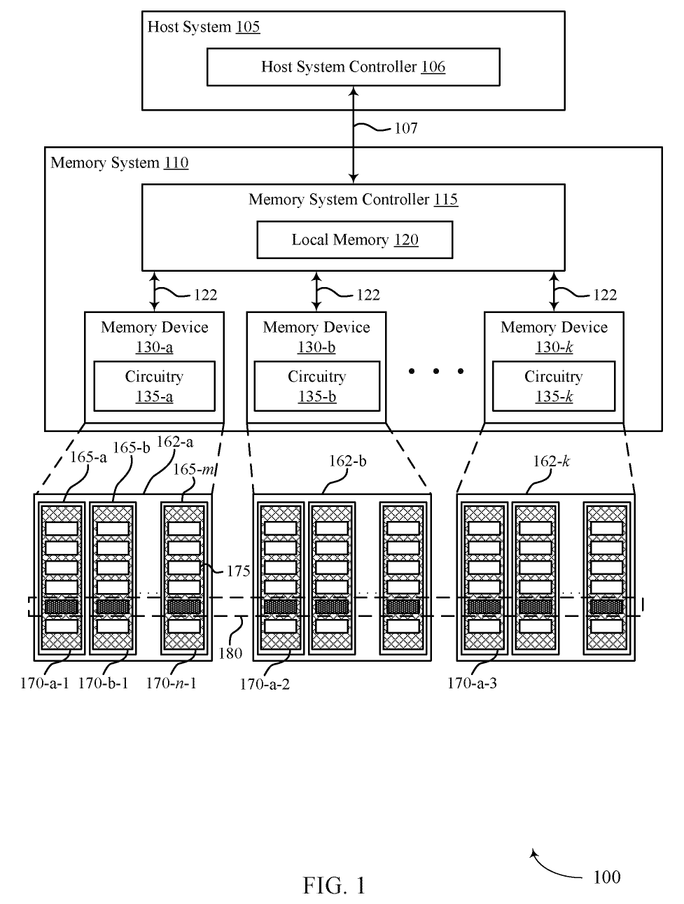

FIG. 1 shows an example of a system 100 that supports data correction switching in multi-die memory systems in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface 107 with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via an interface 107. The host system 105 and the memory system 110 may, in some cases, be configured to communicate via the interface 107 using an associated protocol (e.g., to exchange or otherwise communicate control, address, data, and other signals between the memory system 110 and the host system 105). Examples of the interface 107 may include, but are not limited to, a SATA interface, a UFS interface, an eMMC interface, a PCIe interface, a USB interface, a Fiber Channel interface, a SCSI, a Serial Attached SCSI (SAS) interface, a Double Data Rate (DDR) interface, a DIMM interface (e.g., DIMM socket interface that supports DDR), an Open NAND Flash Interface (ONFI), Mobile Industry Processor Interface (MIPI) Unified Protocol (UniPro), MIPI Physical (M-PHY) interface, and a Low Power Double Data Rate (LPDDR) interface. In some examples, multiple such interfaces 107 may be included in or otherwise supported between a host system controller 106 of the host system 105 and a memory system controller 115 of the memory system 110 (e.g., the interface 107 may support communication via multiple protocol layers such as UFS at an application layer, UniPro at a transport layer, and M-PHY at a physical layer).

The memory system 110 may include a memory system controller 115 and one or more memory devices 130. A memory device 130 may include one or more memory arrays of any type of memory cells (e.g., non-volatile memory cells, volatile memory cells, or any combination thereof). The memory system 110 may include memory devices 130-a, 130-b, up to 130-k, where k represents any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the interface 107) and may be an example of a controller or control component configured to cause the memory system 110 to perform various operations in accordance with examples as described herein. The memory system controller 115 may also be coupled with and communicate with memory devices 130 via respective interfaces 122 to perform operations such as reading data, writing data, erasing data, or refreshing data at a memory device 130—among other such operations—which may generically be referred to as access operations. In some examples, the respective interfaces 122 may be examples of single data rate (SDR) interfaces, DRR interfaces, ONFI interfaces, and the like. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include volatile memory (e.g., static random access memory (SRAM), dynamic random access memory (DRAM), or other memory) that may be used by the memory system controller 115 for internal storage or calculations, for example, related to the functions ascribed herein to the memory system controller 115.

A memory device 130 may include one or more arrays of non-volatile memory cells. For example, a memory device 130 may include NAND (e.g., NAND flash) memory, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as DRAM memory cells or SRAM memory cells.

In some examples, a memory device 130 may include (e.g., on the same die, within the same package) circuitry 135, which may execute or otherwise support operations on one or more memory cells of the respective memory device 130. Respective circuitry 135 may operate in conjunction with a memory system controller 115 or may perform one or more functions ascribed herein to the memory system controller 115. For example, as illustrated in FIG. 1, a memory device 130-a may include circuitry 135-a, a memory device 130-b may include circuitry 135-b, and a memory device 130-k may include circuitry 135-k.

In some cases, a memory device 130 may be or include a NAND device (e.g., NAND flash device). A memory device 130 may be or include a die 162 (e.g., a memory die). For example, in some cases, a memory device 130 may be a package that includes one or more dies 162. A die 162 may, in some examples, be a piece of electronics-grade semiconductor cut from a wafer (e.g., a silicon die cut from a silicon wafer). The memory cells for each die 162 may be arranged in one or more planes 165, and each plane 165 may include one or more blocks 170, where each block 170 may include one or more pages 175, and each page 175 may include a set of memory cells. In some examples, each die 162 may include m planes 165 and each plane may include n blocks 170, where m and n represent positive integers.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, concurrent operations may be performed on different planes 165 or on different blocks 170. For example, concurrent operations may be performed on memory cells within different blocks 170 so long as the different blocks 170 are in different planes 165. In some examples, each memory die 162 may include any quantity of planes 165. For example, the memory die 162-a may include a plane 165-a, a plane 165-b, and a plane 165-m, where m represents an Mth plane. The memory die 162-b and the memory die 162-k may also include m planes. In some cases, an individual block 170 may be referred to as a physical block, and a virtual block 180 may refer to a group of blocks 170 within which concurrent operations may occur. A virtual block 180 may be a logical structure that includes a plurality of blocks 170, where different blocks 170 of the plurality of blocks 170 may come from different planes 165 or different memory dies 162. In some cases, a virtual block 180 may include blocks 170 from different memory devices 130 (e.g., including blocks 170 in one or more planes 165 of memory device 130-a, memory device 130-b, and memory device 130-k). In some examples, a virtual block 180 may include a respective block 170 from each plane 165 (e.g., a block 170 from each plane 165) of one or more memory dies 162.

In some cases, the blocks 170 within a virtual block 180 may have the same block address within their respective planes 165. For example, block 170-a-1 may be “block 0” of a first plane 165 of die 162-a, block 170-a-2 may be “block 0” of a first plane 165 of die 162-b, block 170-a-3 may be “block 0” of a first plane 165 of die 162-k, and so on. By way of further example, block 170-b-1 may be “block 1” of a first plane 165 of die 162-a and block 170-n1 may be “block n” of die 162-a, where n represents an Nth block. The memory die 162-b and the memory die 162-k may also include n blocks. In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). For example, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be restricted from being re-written with new data until they are erased. Thus, for example, an invalid page 175 may, in some cases, not be updated until the entire block 170 that includes the page 175 has been erased.

In some cases, to update some data within a block 170 while retaining other data within the block 170, the memory device 130 may write the updated data to a new block 170. The memory device 130 (e.g., circuitry 135) or the memory system controller 115 may mark or otherwise designate the addresses of the data that was updated in the block 170 as invalid or obsolete and may update a logical-to-physical (L2P) mapping table to associate the logical address (e.g., LBA) for the data with the new block 170 rather than the original block 170. In some cases, such copying and remapping may be performed instead of erasing and rewriting the entire old block 170 due to latency or wearout considerations, for example. In some cases, one or more copies of an L2P mapping table may be stored within the memory cells of the memory device 130 (e.g., within one or more blocks 170 or planes 165) for use (e.g., reference and updating) by circuitry 135 or memory system controller 115.

In some cases, L2P mapping tables may be maintained and data may be marked as valid or invalid at the page level of granularity, and a page 175 may contain valid data, invalid data, or no data. Invalid data may be data that is outdated, which may be due to a more recent or updated version of the data being stored in a different page 175 of the memory device 130. Invalid data may have been previously programmed to the invalid page 175 but may no longer be associated with a valid logical address, such as a logical address referenced by the host system 105. Valid data may be the most recent version of such data being stored on the memory device 130. A page 175 that includes no data may be a page 175 that has never been written to or that has been erased.

In some cases, a memory system controller 115 or circuitry 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

A memory system 110 may be configured to store data in one or more groups of dies 162, which may refer to a group of multiple dies 162 within a memory device 130, or across multiple memory devices 130, or both. A group of dies 162 may be referred to as a “data stripe” and may be located in a compressed region of the memory system 110, such that a data stripe may be configured to store compressed data. In some examples, a data stripe may include ten dies 162, for which eight of the ten dies 162 are configured to store user data and two of the ten dies 162 are configured to store parity information (e.g., Reed-Solomon parity information). A memory system 110 may support accessing data in a data stripe in accordance with a granularity (e.g., an elementary access granularity), and a host system 105 may access a data stripe in accordance with a burst length and a quantity of data buses. For example, an elementary access may include accessing a data stripe of ten dies 162 in accordance with a first burst length (e.g., a burst length of 16) and a first quantity of data buses (e.g., four data buses, in accordance with a 4x mode) to retrieve a quantity of bytes from the data stripe (e.g., 16*4 = 64 bits or 8 bytes per die 162, 8*8 = 64 bytes of data from the eight dies 162 in the data stripe storing user data). In some examples, a data stripe may include multiple groupings of dies 162. For example, a group of ten dies 162 may correspond to a subchannel (e.g., a 40 bit subchannel), and a data stripe may include multiple subchannels (e.g., four subchannels, such that a data stripe may include 40 dies 162). Accessing the user data stored to the data stripe may include accessing each subchannel to retrieve user data stored to dies 162 in each subchannel (e.g., respective sets of eight dies 162, each including 64 bytes of data, resulting in a nominal access size of 256 bytes).

In some examples, a data stripe including multiple subchannels of dies 162 (e.g., a data stripe including 40 dies 162) may be configured with increased capacity by reducing overprovisioning associated with dies 162 storing parity information. For example, instead of configuring two dies 162 in each subchannel for storing parity information (e.g., two parity dies 162 for each eight user data dies 162, in accordance with a 25% provisioning), two dies 162 of the data stripe may be configured to store the parity information for the rest of the data stripe (e.g., for a data stripe including 40 dies 162, two dies 162 may store parity information and 38 dies 162 may support storing user information). The resulting data stripe may support a payload of 304 bytes (e.g., 8 bytes per die 162 of the 38 dies 162 configured to store user data) and 16 bytes of parity information (e.g., 8 bytes per die 162 of the two dies configured to store user data). In some examples, such a data stripe may support an SDDC mode. For example, the parity information in the two dies 162 configured to store the parity information for the data stripe may be sufficient to correct an error (e.g., a chip kill event) that occurs at any one of the 38 dies 162 of the data stripe storing user information. In some implementations, a memory system 110 may support a DDDC mode, where parity information is sufficient to correct errors among two dies 162 (e.g., two chip kill events) within a data stripe. The DDDC mode may be configured such that more than two dies 162 (e.g., four dies 162) of the data stripe may store parity information, thereby providing increased error correction capabilities.

In response to detecting an error in a die 162 storing user data in a data stripe, the memory system 110 may use parity information to reconstruct the user data stored to the die 162. For example, the memory system 110 may use the parity information to identify a position and data pattern associated with the error and may reconstruct the user data in accordance with the parity information and reading user data stored to dies 162 of the data stripe configured to store user data (e.g., different from the die 162 in which the error was detected). In some examples, the memory system 110 may write the reconstructed user data to an available die 162 of the data stripe (e.g., a replacement die 162), which may support the memory system 110 continuing to store the user data while allowing the parity information to correct a subsequent error in the data stripe. For example, the available die 162 may be a die 162 that is unused due to the data stored in the data stripe reaching the elementary access granularity (e.g., 256B), such that a portion of dies 162 may be available for storing user data (e.g., six dies 162 repurposed from being used to store parity information). In some examples, an error may be due to faults or defects in physical components of the memory system 110 (e.g., access lines, memory cells), and the memory system 110 may retire a portion of the die 162 (e.g., the entire die 162, a bank of the die 162, a section of the die 162) including the error after reconstructing the user data in the replacement die 162. By writing the reconstructed user data to the available die 162 and maintaining parity information stored to two dies 162 of a data stripe, the memory system 110 may leverage advantages of a DDDC mode (e.g., providing capability to correct errors in multiple dies 162 of the data stripe) while reducing an allocation of dies 162 storing parity information (e.g., maintaining an SDDC mode, and enhanced SDDC mode).

Reading the user data from a die 162, reconstructing user data in accordance with the parity information, and writing the reconstructed user data to a replacement die 162 (e.g., a read-modify-write operation) may occur over a duration, which may be referred to as a switching window. For example, after detecting an error (e.g., a first chip kill event, associated with a first die 162, or portion thereof), the memory system 110 may perform a read-modify-write operation to support correction of a possible future error (e.g., a second chip kill event, associated with a second die 162, or portion thereof) during the switching window, which may include a duration associated with reading the user data of the data stripe, reconstructing the user data at the die 162 including the error in accordance with the parity information and the user data of the data stripe, and writing the reconstructed user data to the replacement die 162. However, during such a switching window, the memory system 110 may be susceptible to additional (e.g., uncorrectable) errors. For example, if a second chip kill event occurs within a data stripe during the switching window, an error associated with the second chip kill event may be uncorrectable.

Techniques described herein provide for a memory system 110 to enter a reduced accessibility mode while correcting an error in a group of memory dies 162 (e.g., a data stripe). In some examples, the memory system 110 may transmit an indication (e.g., to a host system 105) that the memory system 110 enters the reduced accessibility mode in response to detecting an error in the group of memory dies 162. The reduced accessibility mode may indicate that one or more data buses associated with the group of memory dies 162 are inaccessible by the host system 105. For example, the data bus(es) may be configured to transfer information between the group of memory dies 162 and a queue (e.g., a queue for the host system 105 to input access data), and, while operating in the reduced accessibility mode, the memory system 110 may inhibit the data bus(es) from transferring information between the group of memory dies 162 and the queue. In some examples, the reduced accessibility mode may be applicable to the group of memory dies 162 and one or more second groups of memory dies 162 that share the data bus(es) with the group of memory dies 162 (e.g., other ranks or groups of memory dies 162). In some such examples, the reduced accessibility mode may not be applicable to one or more third groups of memory dies 162 that do not share the data bus(es) with the group of memory dies 162 (e.g., one or more groups of memory dies may continue to operating in accordance with a baseline operating mode while another one or more groups of memory dies operate in accordance with the reduced accessibility mode). Such techniques may prevent additional (e.g., uncorrectable) errors from being experienced among the group of memory dies 162 due to the host system 105 attempting to access data in the group of memory dies 162 while the memory system corrects an error in the group of memory dies 162. Further, by supporting baseline operations at the one or more third groups of memory dies 162, the memory system 110 may mitigate adverse effects (e.g., access latency) associated with operating in the reduced accessibility mode. In some implementations, such techniques may be implemented to support SDDC techniques (e.g., error correction for a single die) for correcting errors of multiple dies (e.g., at different times), providing at least some of the advantages of DDDC techniques, but with reduced parity and die allocations (e.g., blending aspects of SDDC and DDDC techniques)

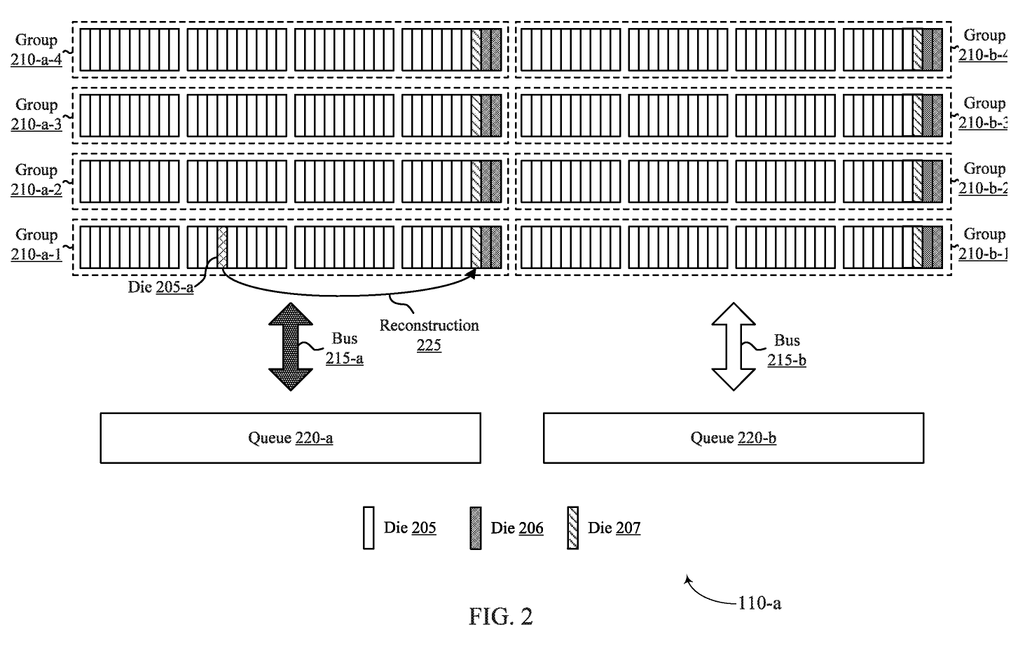

FIG. 2 shows an example of a memory system 110-a that supports data correction switching in multi-die memory systems in accordance with examples as disclosed herein. The memory system 110-a may implement, or be implemented by, one or more aspects of the system 100. For example, the memory system 110-a may be an example of or otherwise be included in a memory system 110 described with reference to FIG. 1. The memory system 110-a may include one or more memory dies, such as dies 205 (e.g., first memory dies), dies 206 (e.g., second memory dies), and dies 207 (e.g., third memory dies), each of which may be examples of dies 162 described with reference to FIG. 1. The memory system 110-a may support error detection and correction techniques in accordance with a reduced accessibility mode, which may prevent uncorrectable errors at the memory system 110-a.

Aspects of the memory system 110-a may be configured in accordance with one or more groups 210, which may be groups of memory dies (e.g., data stripes). For example, each group 210 may include a set of dies 205 (e.g., multiple first memory dies), one or more dies 206 (e.g., one or more second memory dies), and a die 207 (e.g., a third memory die). In some cases, within each group 210, a die 205 may be configured to store user data, a die 206 may be configured to store parity information associated with user data of the die(s) 205, and a die 207 may be a replacement die (e.g., a die available to store user data, a die originally configured to not store user data, parity data, or both). In some cases, the dies of a group 210 (e.g., the dies 205, the dies 206, and the die 207 associated with the same data stripe) may be associated with a same capacity (e.g., a same size, a same storage configuration, a same storage granularity).

In an example implementation, each group 210 may include forty dies 162, of which thirty seven may be dies 205, two may be dies 206, and one may be a die 207. In such an implementation, parity information stored in the two dies 206 may support an SDDC mode in which a failure of any one of the dies 205 may be corrected, and a failed die 205 may be replaced by the die 207. The SDDC mode may be maintained after such a replacement, again supported by the two dies 206, for example. Accordingly, such an implementation may support failures of two dies 205, so long as such failures do not occur concurrently (e.g., which may implement four dies 206 to provide enough space for parity information that supports a true DDDC mode). Thus, the described techniques may support the correction of failures in two dies 162 (e.g., in accordance with different SDDC modes) with fewer dies 162 than a true DDDC mode, which may reduce cost, reduce size, or reduce power consumption, among other benefits.

In some examples, a group 210 may be configured to transfer access data (e.g., data to be read from a group 210, data to be written to a group 210) between a respective queue 220 via a respective bus 215. For example, a host system 105 may input access data to a queue 220 to be transferred to and from a group 210 via a bus 215. A bus 215 may be an example of one or more conductive lines configured to transfer information, and may include any quantity of connections between groups 210 and queues 220. Additionally, although a bus 215-a and a bus 215-b are illustrated as being connected with (e.g., configured to transfer information to and from) a queue 220-a and a queue 220-b, respectively, the bus 215-a and the bus 215-b may be connected with a single queue 220, respective regions of a single queue 220, respective sets of multiple queues 220, among other suitable configurations.

In some implementations, multiple groups 210 may be configured to share a bus 215 for performing access operations. For example, a group 210-a-1, a group 210-a-2, a group 210-a-3, and a group 210-a-4 (e.g., a first set of one or more groups of memory dies) may share a bus 215-a and a group 210-b-1, a group 210-b-2, a group 210-b-3, and a group 210-b-4 may share a bus 215-b. In some cases, each group 210 sharing a bus 215 may be referred to as a respective rank of the memory system 110-a. For example, in a multi-rank die configuration, the group 210-a-1 and the group 210-b-1 may correspond to a first rank of the memory system 110-a, the group 210-a-2 and the group 210-b-2 may correspond to a second rank of the memory system 110-a, the group 210-a-3 and the group 210-b-3 may correspond to a third rank of the memory system 110-a, and the group 210-a-4 and the group 210-b-4 may correspond to a fourth rank of the memory system 110-a.

The memory system 110-a (e.g., processing circuitry of the memory system 110-a, such as a memory system controller 115, firmware of the memory system 110-a) may support operations and techniques for detection and correction of errors in user data stored to dies 205. For example, the memory system 110-a may detect (e.g., during an operation, such as a prefetch operation) that a die 205-a (e.g., a first memory die) of the group 210-a-1 includes an error. In some cases, the memory system 110-a may use parity information stored to the dies 206 of the group 210-a-1 to correct the error. For example, the memory system 110-a may identify a position and data pattern associated with the error based on reading the parity information from the dies 206 of the group 210-a-1 and at least some of the user data stored to the dies 205 of the group 210-a-1 (e.g., user data from the die 205-a, one or more other dies 205 of the group 210-a-1, or any combination thereof), and may reconstruct a portion of the user data associated with the die 205-a.

In some examples, an error in a die 205 may be due to faults or defects in physical components of the die 205. For example, one or more access lines or storage elements of the die 205-a may fail to operate in accordance with baseline storage techniques, thereby resulting in the error at the die 205-a. In such examples, the memory system 110-a may refrain from storing reconstructed user data back to the die 205-a (e.g., to prevent similar errors from occurring), and may instead write the reconstructed user data (e.g., of the die 205-a) to the replacement die 207 of the group 210-a-1. For example, the memory system 110-a may perform a reconstruction 225 (e.g., a read-modify-write operation), which may include reading the portion of the user data from the dies 205 of the group 210-a-1 (e.g., a second portion of the user data from dies 205 of the group 210-a-1 different from the die 205-a) and reading the parity information from the dies 206 of the group 210-a-1, reconstructing the portion (e.g., a first portion) of the user data associated with the die 205-a using the second portion of the user data and the parity information, and writing the reconstructed first portion of the user data to the die 207 of the group 210-a-1.

In some cases, the memory system 110-a (e.g., a memory system controller 115) may perform the reconstruction 225 in accordance with a reduced accessibility mode. For example, the memory system 110-a may, in response to detecting the error at the die 205-a, transmit an indication (e.g., to a host system 105) that the memory system 110-a enters the reduced accessibility mode. The reduced accessibility mode may be associated with the group 210 including the error (e.g., the group 210-a-1) and may indicate that the bus 215-a associated with the group 210-a-1 is not accessible (e.g., by a host system 105). In some implementations, the memory system 110-a may indicate that the reduced accessibility mode is associated with one or more other groups 210 that share the bus 215-a with the group 210-a-1 (e.g., the groups 210-a-2, 210-a-3, and 210-a-4). For example, a host system 105 may be unable to access the groups 210-a-1, 210-a-2, 210-a-3, and 210-a-4 while the memory system 110-a operates in the reduced accessibility mode as a result of the data bus 215-a, or a subset of buses (e.g., subchannels) included in the bus 215-a, being inaccessible.

As a result of operating in the reduced accessibility mode, the memory system 110-a may reduce a probability of additional (e.g., uncorrectable) errors in the group 210-a-1 while the memory system 110-a performs the reconstruction 225. For example, if a host system 105 attempts to access the group 210-a-1 while the memory system 110-a performs the reconstruction 225, an error that occurs in a die 205 as a result of such an access may be uncorrectable using the parity information stored to the dies 206 (e.g., due to the memory system 110-a using the parity information to correct the first error). Additionally, or alternatively, accessing other groups 210-a (e.g., groups 210-a-2, 210-a-3, and 210-a-4) that share the bus 215-a may rely on operations of the queue 220-a, which may prolong the reconstruction 225 and cause the memory system 110-a to be more vulnerable to other errors in the group 210-a-1.

In some examples, the reduced accessibility mode may not affect operations of groups 210 that do not share the bus 215-a with the group 210-a-1. For example, the group 210-b-1, the group 210-b-2, the group 210-b-3, and the group 210-b-4 (e.g., a second set of one or more groups of memory dies) may transfer information via the bus 215-b, which may be separate and distinct from the bus 215-a. The memory system 110-a may operate the groups 210-b in accordance with a baseline operating mode (e.g., maintaining accessibility to a host system 105) while the memory system 110-a operates in the reduced accessibility mode and performs the reconstruction 225. Thus, the memory system 110-a may mitigate access latency associated with operating in the reduced accessibility mode by allowing a host system 105 to continue to access the groups 210-b via the bus 215-b.

In some cases, the memory system 110-a may complete the reconstruction 225 by writing the reconstructed user data to the die 207 of the group 210-a-1. In some examples, the memory system 110-a may update the parity information stored to the dies 206 of the group 210-a-1 in accordance with the reconstructed user data in the die 207. For example, the memory system 110-a may write second parity information to the dies 206 that replaces a portion of the parity information previously stored to the dies 206 (e.g., updating the parity information to account for the new location of the reconstructed user data). Such techniques may enable the memory system 110-a to correct a second error in the group 210-a-1 using the updated parity information.

The memory system 110-a may determine whether to retire a portion of the die 205-a after performing the reconstruction 225. For example, the memory system 110-a may determine that one or more physical components of the die 205-a are not operating correctly, and may retire a portion of the die 205-a. In some cases, the portion of the user data including the error, or the user data associated with the reconstruction 225, or both may correspond to all of the user data stored by the die 205-a, and the memory system 110-a may retire the die 205-a (e.g., the entire die 205-a) from further access operations. In some other cases, the portion of the user data including the error, or the user data associated with the reconstruction 225, or both may correspond to a subset of the user data stored by the die 205-a. For example, the portion of the user data including the error may correspond to a bank of the die 205-a, or a section of the die 205-a, among other subdivisions of the memory die 205-a. In such examples, the memory system 110-a may retire the bank, section, or other subset of the die 205-a, and may maintain a remaining portion of the die 205-a for subsequent access operations (e.g., in accordance with a reconstruction 225 associated with less than the entire die 205-a). In some such examples, when reconstructing the portion of user data from a bank, section, or other subset of the die 205-a, the memory system 110-a may write the reconstructed user data to the die 207 in accordance with a similar granularity (e.g., writing to a bank, section, or other subset of the die 207, in accordance with a partial reconstruction 225).

After performing the reconstruction 225, the memory system 110-a may transmit a second indication of an exit from the reduced accessibility mode. For example, the memory system 110-a may indicate that the bus 215-a is available for access by the host system and may support further access operations at the groups 210-a after the exit from the reduced accessibility mode.

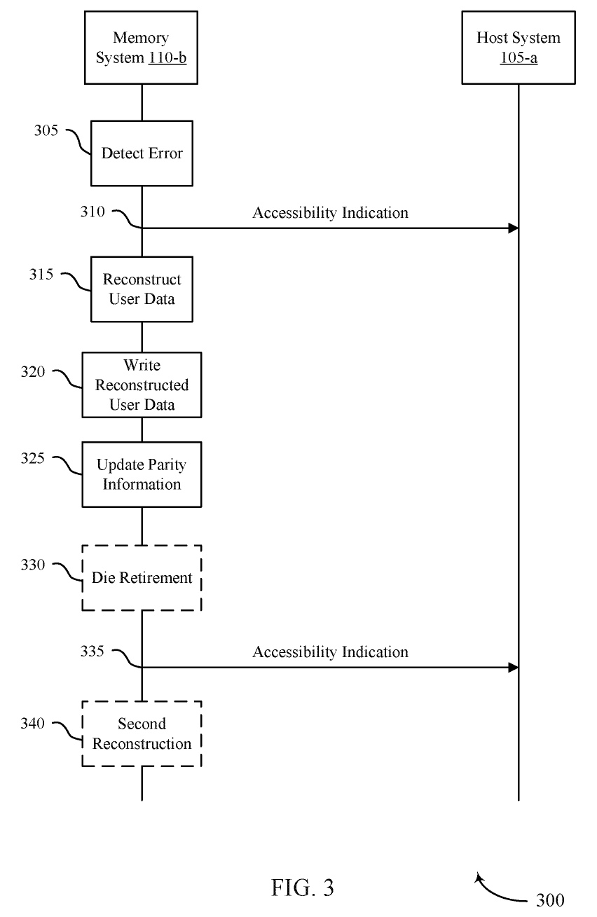

FIG. 3 shows an example of a process 300 that supports data correction switching in multi-die memory systems in accordance with examples as disclosed herein. The process 300 may implement, or be implemented by, one or more aspects of the system 100 and the memory system 110-a (e.g., described with reference to FIG. 2). For example, the process 300 shows operations by and signaling between a host system 105-a and a memory system 110-b. The process 300 may support the memory system 110-b correcting an error in a group of memory dies (e.g., a data stripe, a group 210) in accordance with a reduced accessibility mode, which may prevent or reduce uncorrectable errors being experienced at the memory system 110-a.

The memory system 110-b may include multiple groups of memory dies (e.g., groups 210) each including multiple first memory dies (e.g., dies 205) configured to store user data, one or more second memory dies (e.g., dies 206) configured to store parity information, and a third memory die (e.g., a die 207). The memory system 110-b may include one or more data buses (e.g., data buses 215) coupled with the multiple groups of memory dies and configured to transfer information between the multiple groups of memory dies and the host system 105-a (e.g., via one or more queues 220). In some examples, a group of memory dies may correspond to forty memory dies, for which the first memory dies (e.g., the dies 205) may be thirty-seven of the forty memory dies, the one or more second memory dies (e.g., the dies 206) may be two of the forty memory dies, and the third memory die (e.g., the die 207) may be one of the forty memory dies. In some cases, each of the first memory dies, the one or more second memory dies, and the third memory die may be associated with the same capacity.

At 305, the memory system 110-b may detect an error at a first memory die (e.g., the die 205-a) of a group of memory dies (e.g., the group 210-a-1). In some examples, the memory system 110-b may detect the error during an access operation, such as a prefetch operation. The memory system 110-b may detect the error in a first portion of user data associated with the first memory die. In some examples, the first portion of the user data may correspond to all of the user data stored by the first memory die. In some other examples, the first portion of the user data may correspond to a portion of the user data stored by a first portion of the first memory die (e.g., a subset of the user data stored by the first memory die, less than all of the data stored by the first memory die), such as user data stored to a bank of the first memory die, a second of the first memory die, or another subset of the first memory die.

At 310, the memory system 110-b may transmit an accessibility indication. For example, the memory system 110-b may transmit an indication of a reduced accessibility mode associated with the group of memory dies (e.g., the group 210-a-1), which may be received by the host system 105-a. In some cases, in accordance with the reduced accessibility mode, one or more data buses (e.g., the bus 215-a) may not be accessible by the host system 105-a. In some cases, the memory system 110-b may indicate that the reduced accessibility mode is associated with a first set of one or more groups of memory dies (e.g., the groups 210-a), including the group of memory dies (e.g., including the group 210-a-1), that are associated with the one or more data buses. In some cases, in accordance with the reduced accessibility mode, the memory system 110-b may continue to operate a second set of one or more groups of memory dies (e.g., the groups 210-b), associated with a second data bus (e.g., the data bus 215-b), in accordance with a baseline operating mode. For example, the memory system 110-b may not reduce accessibility to the second set of one or more groups of memory dies or the second data bus.

At 315, the memory system 110-b may reconstruct the first portion of the user data associated with the first memory die (e.g., in accordance with a reconstruction 225). For example, the memory system 110-b may reconstruct the first portion of the user data based on a reading a second portion of the user data from the multiple first memory dies different from the first memory dies (e.g., other dies 205 of the group 210-a-1) and reading parity information from the one or more second memory dies (e.g., dies 206 of the group 210-a-1). In some cases, the memory system 110-b may reconstruct the first portion of the user data in accordance with the reduced accessibility mode (e.g., the bus 215-a may be inaccessible to the host system 105-a while the memory system 110-b reconstructs the first portion of the user data).

At 320, the memory system 110-b may write the reconstructed user data. For example, the memory system 110-b may write the reconstructed first portion of the user data to the third memory die (e.g., the die 207 of the group 210-a-1). In some examples, the memory system 110-b may write the reconstructed user data in accordance with a granularity of the user data stored by the first memory die that includes the error. For example, if the first portion of the user data corresponds to all the user data stored by the first memory die, the memory system 110-b may write the reconstructed first portion of the user data to all of the third memory die. In another example, if the first portion of the user data corresponds to a portion (e.g., less than all) of the user data stored by the first memory die, the memory system 110-b may write the reconstructed first portion of the user data to a corresponding portion of the third memory die (e.g., to a bank of the die 207, a section of the die 207, or another subset of the die 207).

At 325, the memory system 110-b may update the parity information stored to the one or more second memory dies. For example, the memory system 110-b may write second parity information to the one or more second memory dies (e.g., the dies 206) based on writing the reconstructed first portion of the user data to the third memory die (e.g., the die 207). The second parity information may replace a portion of the parity information, for example to update the parity information in accordance with the new position of the first portion of the user data (e.g., moving the first portion of the user data from the first memory die to the third memory die). Updating the parity information may support further error detection and correction at the group of memory dies using the second parity information.

At 330, the memory system 110-b may retire a portion of the first memory die (e.g., all of the first memory die, less than all of the first memory die). For example, if the first portion of the user data, or the reconstruction of 315, or both corresponds to all of the user data stored by the first memory die, the memory system 110-b may retire the first memory die (e.g., the entire die 205-a) from further access operations after writing the reconstructed first portion of the user data to the third memory die. In another example, if the first portion of the user data, or the reconstruction of 315, or both corresponds to a first portion of the user data stored by the first memory die (e.g., a bank, a section, or another subset of the first memory die), the memory system 110-b may retire the first portion of the first memory die from further access operations after writing the reconstructed first portion of the user data to the corresponding portion of the third memory die. In such examples, the memory system 110-b may continue to support further access operations on a second portion of the first memory die (e.g., portions of the die 205-a that did not include the error, the memory system 110-b may not retire the entire die 205-a).

At 335, the memory system 110-b may transmit a second accessibility indication. For example, the memory system 110-b may transmit an indication of an exit from the reduced accessibility mode associated with the group of memory dies based on writing the reconstructed first portion of the user data to the third memory die. In some examples, the memory system 110-b may support further access operations at the group of memory dies in accordance with a baseline operating mode after transmitting the indication of the exit from the reduced accessibility mode.

At 340, the memory system 110-b may perform a second reconstruction of suer data. For example, the memory system 110-b may detect a second error at a fourth memory die of the multiple first memory dies different from the first memory die and the third memory die (e.g., a die 205 different from the die 205-a, or the die 207). In some examples, the memory system 110-b may enter the reduced accessibility mode and may reconstruct a third portion of the user data associated with the fourth memory die based on reading a fourth portion of the user data (e.g., from the dies 205 different than the die 205-a and the die 205 or die 207 including the error) and reading the second parity information from the one or more second memory dies (e.g., the dies 206). The memory system 110-b may retire a portion of the fourth memory die (e.g., all of the fourth memory die, less than all of the fourth memory die) and may exit the reduced accessibility mode based on writing the reconstructed third portion of the user data to a fifth memory die (e.g., another die 207 used as a replacement die). In some examples, the second reconstruction may maintain an SDDC mode for the memory system 110-b (e.g., maintaining two dies 206 for storing parity information while being capable of correcting the second error in the group 210-a-1).

Such techniques may prevent formation of uncorrectable errors at the memory system 110-b by restricting access to a group of memory dies while the memory system 110-b performs a read-modify-write operation to correct an error at the group of memory dies. Additionally, such techniques may support the memory system 110-b leveraging enhanced error correction capabilities of a DDDC mode while maintaining reduced die allocation for storing parity information, for example by maintaining an SDDC mode where two dies are provisioned to store parity information (e.g., performing reconstruction(s) in the reduced accessibility mode may support maintaining the SDDC mode and reducing hardware allocations for data correction).

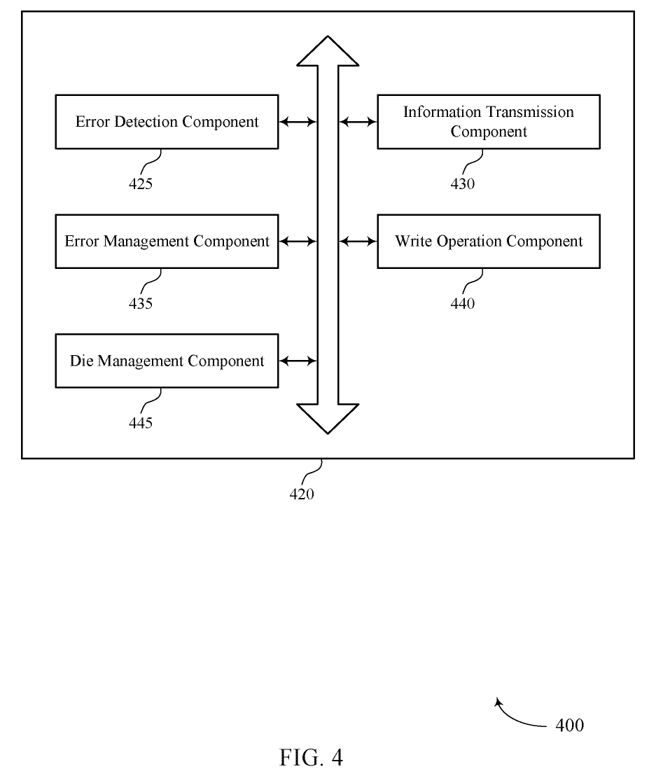

FIG. 4 shows a block diagram 400 of a memory system 420 that supports data correction switching in multi-die memory systems in accordance with examples as disclosed herein. The memory system 420 may be an example of aspects of a memory system as described with reference to FIGS. 1-3. The memory system 420, or various components thereof, may be an example of means for performing (e.g., to cause the memory system 420 to perform) various aspects of data correction switching in multi-die memory systems as described herein. For example, the memory system 420 may include an error detection component 425, an information transmission component 430, an error management component 435, a write operation component 440, a die management component 445, or any combination thereof. Each of these components, or components of subcomponents thereof (e.g., one or more processors, one or more memories), may communicate, directly or indirectly, with one another (e.g., via one or more buses).

The error detection component 425 may be configured as or otherwise support a means for detecting an error at a first memory die of a group of memory dies of the memory system 420, the group of memory dies including: a plurality of first memory dies configured to store user data, one or more second memory dies configured to store parity information, and a third memory die. The information transmission component 430 may be configured as or otherwise support a means for transmitting an indication of a reduced accessibility mode associated with the group of memory dies based on detecting the error. The error management component 435 may be configured as or otherwise support a means for reconstructing a first portion of the user data associated with the first memory die in accordance with the reduced accessibility mode, where reconstructing the first portion of the user data is based on reading a second portion of the user data from the plurality of first memory dies different from the first memory die and reading the parity information from the one or more second memory dies. The write operation component 440 may be configured as or otherwise support a means for writing the reconstructed first portion of the user data to the third memory die in accordance with the reduced accessibility mode.

In some examples, in accordance with the reduced accessibility mode, one or more data buses associated with the group of memory dies are not accessible by a host system.

In some examples, the write operation component 440 may be configured as or otherwise support a means for writing second parity information to the one or more second memory dies based on writing the reconstructed first portion of the user data to the third memory die, the second parity information replacing a portion of the parity information.

In some examples, the information transmission component 430 may be configured as or otherwise support a means for transmitting a second indication of an exit from the reduced accessibility mode associated with the group of memory dies based on writing the reconstructed first portion of the user data to the third memory die.

In some examples, the first portion of the user data corresponds to all of the user data stored by the first memory die, and the die management component 445 may be configured as or otherwise support a means for retiring the first memory die from further access operations after writing the reconstructed first portion of the user data to the third memory die.

In some examples, the error corresponds to a first portion of the first memory die, and the write operation component 440 may be configured as or otherwise support a means for writing the reconstructed first portion of the user data to a corresponding portion of the third memory die. In some examples, the error corresponds to a first portion of the first memory die, and the die management component 445 may be configured as or otherwise support a means for retiring the first portion of first memory die from further access operations after writing the reconstructed first portion of the user data to the corresponding portion of the third memory die. In some examples, the error corresponds to a first portion of the first memory die, and the die management component 445 may be configured as or otherwise support a means for supporting further access operations on a second portion of the first memory die after writing the reconstructed first portion of the user data to the corresponding portion of the third memory die.

In some examples, to support indication of the reduced accessibility mode, the information transmission component 430 may be configured as or otherwise support a means for indicating that the reduced accessibility mode is associated with a first set of one or more groups of memory dies, including the group of memory dies, associated with a data bus.

In some examples, the die management component 445 may be configured as or otherwise support a means for operating a second set of one or more groups of memory dies, associated with a second data bus, in accordance with a baseline operating mode during operations of the set of one or more groups of memory dies in accordance with the reduced accessibility mode.

In some examples, each group of memory dies of the set of groups of memory dies corresponds to a respective rank of the memory system 420.

In some examples, the error detection component 425 may be configured as or otherwise support a means for detecting a second error at a fourth memory die, of the plurality of first memory dies different from the first memory die and the third memory die. In some examples, the error management component 435 may be configured as or otherwise support a means for reconstructing a third portion of the user data associated with the fourth memory die based on reading a fourth portion of the user data, of the plurality of first memory dies and the third memory die different from the first memory die and the fourth memory die, and reading second parity information from the one or more second memory dies.

In some examples, the group of memory dies corresponds to forty memory dies, of which the plurality of first memory dies are thirty-seven of the forty memory dies, the one or more second memory dies are two of the forty memory dies, and the third memory die is one of the forty memory dies.

In some examples, each of the plurality of first memory dies, the one or more second memory dies, and the third memory die is associated with the same capacity.

In some examples, the error detection component 425 may be configured as or otherwise support a means for detecting an error in a portion of a first memory die of a group of memory dies of the memory system 420, the group of memory dies including a plurality of first memory dies configured to store user data, one or more second memory dies configured to store parity information, and a third memory die. In some examples, the information transmission component 430 may be configured as or otherwise support a means for transmitting an indication of a reduced accessibility mode associated with the group of memory dies based on detecting the error. In some examples, the error management component 435 may be configured as or otherwise support a means for reconstructing a first portion of user data associated with the portion of the first memory die in accordance with the reduced accessibility mode, where reconstructing the first portion of the user data is based on reading a second portion of the user data from portions of the plurality of first memory dies different from the first memory die and reading the parity information from the one or more second memory dies. The die management component 445 may be configured as or otherwise support a means for retiring the portion of the first memory die based on reconstructing the first portion of the user data.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements) that are configured to cause the memory system 420 to perform one or more operations. In some examples, the described functionality of the memory system 420, or various components thereof, may be implemented at least in part by instructions (e.g., stored in memory, non-transitory computer-readable medium) executable by such at least one processor to cause the memory system 420 to perform one or more operations.

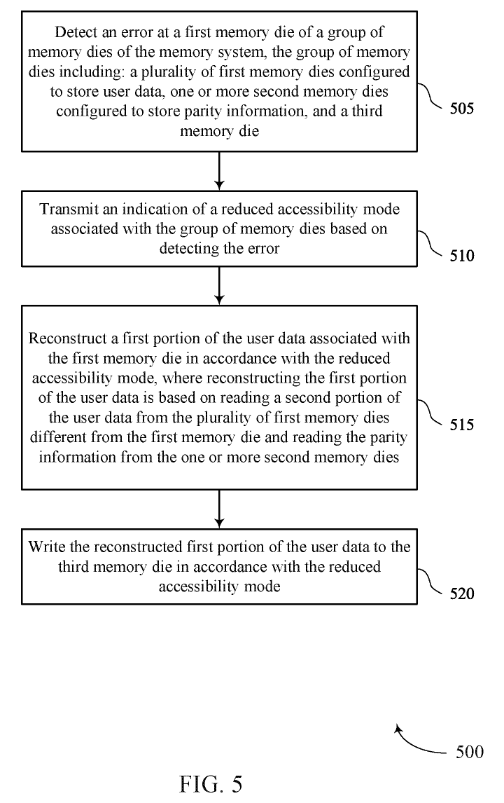

FIG. 5 shows a flowchart illustrating a method 500 that supports data correction switching in multi-die memory systems in accordance with examples as disclosed herein. The operations of method 500 may be implemented by a memory system (e.g., a memory system 110) or its components as described herein (e.g., a memory system controller 115). For example, the operations of method 500 may be performed by a memory system as described with reference to FIGS. 1-4. In some examples, a memory system may execute a set of instructions to control the functional elements of the device to perform the described functions. Additionally, or alternatively, the memory system may perform aspects of the described functions using special-purpose hardware.

At 505, the method may include detecting an error at a first memory die of a group of memory dies of the memory system, the group of memory dies including: a plurality of first memory dies configured to store user data, one or more second memory dies configured to store parity information, and a third memory die. In some examples, aspects of the operations of 505 may be performed by an error detection component 425.

At 510, the method may include transmitting an indication of a reduced accessibility mode associated with the group of memory dies based on detecting the error. In some examples, aspects of the operations of 510 may be performed by an information transmission component 430.

At 515, the method may include reconstructing a first portion of the user data associated with the first memory die in accordance with the reduced accessibility mode, where reconstructing the first portion of the user data is based on reading a second portion of the user data from the plurality of first memory dies different from the first memory die and reading the parity information from the one or more second memory dies. In some examples, aspects of the operations of 515 may be performed by an error management component 435.

At 520, the method may include writing the reconstructed first portion of the user data to the third memory die in accordance with the reduced accessibility mode. In some examples, aspects of the operations of 520 may be performed by a write operation component 440.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for detecting an error at a first memory die (e.g., a first die 205) of a group of memory dies (e.g., a group 210) of the memory system, the group of memory dies including: a plurality of first memory dies (e.g., dies 205) configured to store user data, one or more second memory dies (e.g., die(s) 206) configured to store parity information, and a third memory die (e.g., a die 207); transmitting an indication of a reduced accessibility mode associated with the group of memory dies based on detecting the error; reconstructing a first portion of the user data associated with the first memory die in accordance with the reduced accessibility mode, where reconstructing the first portion of the user data is based on reading a second portion of the user data from the plurality of first memory dies different from the first memory die (e.g., second die(s) 205) and reading the parity information from the one or more second memory dies; and writing the reconstructed first portion of the user data to the third memory die in accordance with the reduced accessibility mode.

Aspect 2: The method, apparatus, or non-transitory computer-readable medium of aspect 1, where in accordance with the reduced accessibility mode, one or more data buses (e.g., bus(es) 215) associated with the group of memory dies are not accessible by a host system.

Aspect 3: The method, apparatus, or non-transitory computer-readable medium of any of aspects 1 through 2, further including operations, features, circuitry, logic, means, or instructions, or any combination thereof for writing second parity information to the one or more second memory dies based on writing the reconstructed first portion of the user data to the third memory die, the second parity information replacing a portion of the parity information.

Aspect 4: The method, apparatus, or non-transitory computer-readable medium of any of aspects 1 through 3, further including operations, features, circuitry, logic, means, or instructions, or any combination thereof for transmitting a second indication of an exit from the reduced accessibility mode associated with the group of memory dies based on writing the reconstructed first portion of the user data to the third memory die.

Aspect 5: The method, apparatus, or non-transitory computer-readable medium of any of aspects 1 through 4, where the first portion of the user data corresponds to all of the user data stored by the first memory die and the method, apparatuses, and non-transitory computer-readable medium further includes operations, features, circuitry, logic, means, or instructions, or any combination thereof for retiring the first memory die from further access operations after writing the reconstructed first portion of the user data to the third memory die.

Aspect 6: The method, apparatus, or non-transitory computer-readable medium of any of aspects 1 through 5, where the error corresponds to a first portion of the first memory die and the method, apparatuses, and non-transitory computer-readable medium further includes operations, features, circuitry, logic, means, or instructions, or any combination thereof for writing the reconstructed first portion of the user data to a corresponding portion of the third memory die; retiring the first portion of first memory die from further access operations after writing the reconstructed first portion of the user data to the corresponding portion of the third memory die; and supporting further access operations on a second portion of the first memory die after writing the reconstructed first portion of the user data to the corresponding portion of the third memory die.

Aspect 7: The method, apparatus, or non-transitory computer-readable medium of any of aspects 1 through 6, where the indication of the reduced accessibility mode includes operations, features, circuitry, logic, means, or instructions, or any combination thereof for indicating that the reduced accessibility mode is associated with a first set of one or more groups of memory dies, including the group of memory dies, associated with a data bus.

Aspect 8: The method, apparatus, or non-transitory computer-readable medium of aspect 7, further including operations, features, circuitry, logic, means, or instructions, or any combination thereof for operating a second set of one or more groups of memory dies, associated with a second data bus, in accordance with a baseline operating mode during operations of the set of one or more groups of memory dies in accordance with the reduced accessibility mode.

Aspect 9: The method, apparatus, or non-transitory computer-readable medium of any of aspects 7 through 8, where each group of memory dies of the set of groups of memory dies corresponds to a respective rank of the memory system.

Aspect 10: The method, apparatus, or non-transitory computer-readable medium of any of aspects 1 through 9, further including operations, features, circuitry, logic, means, or instructions, or any combination thereof for detecting a second error at a fourth memory die, of the plurality of first memory dies different from the first memory die and the third memory die and reconstructing a third portion of the user data associated with the fourth memory die based on reading a fourth portion of the user data, of the plurality of first memory dies and the third memory die different from the first memory die and the fourth memory die, and reading second parity information from the one or more second memory dies.

Aspect 11: The method, apparatus, or non-transitory computer-readable medium of any of aspects 1 through 10, where the group of memory dies corresponds to forty memory dies, of which the plurality of first memory dies are thirty-seven of the forty memory dies, the one or more second memory dies are two of the forty memory dies, and the third memory die is one of the forty memory dies.

Aspect 12: The method, apparatus, or non-transitory computer-readable medium of any of aspects 1 through 11, where each of the plurality of first memory dies, the one or more second memory dies, and the third memory die is associated with the same capacity.

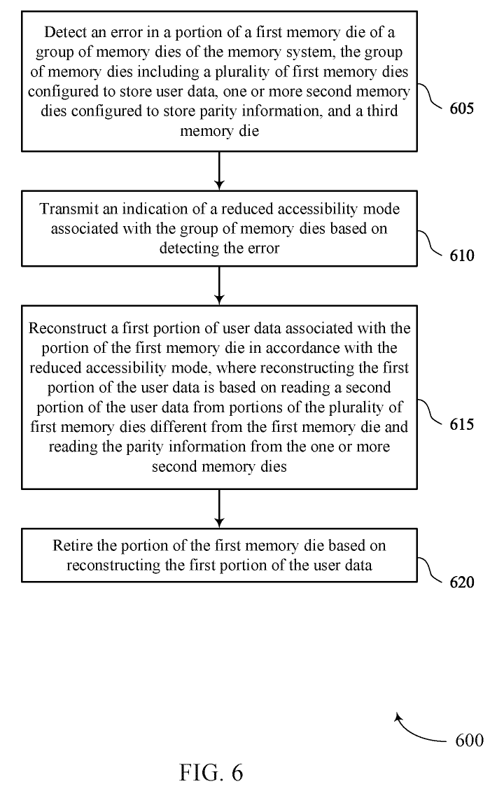

FIG. 6 shows a flowchart illustrating a method 600 that supports data correction switching in multi-die memory systems in accordance with examples as disclosed herein. The operations of method 600 may be implemented by a memory system (e.g., a memory system 110) or its components (e.g., a memory system controller 115) as described herein. For example, the operations of method 600 may be performed by a memory system as described with reference to FIGS. 1-4. In some examples, a memory system may execute a set of instructions to control the functional elements of the device to perform the described functions. Additionally, or alternatively, the memory system may perform aspects of the described functions using special-purpose hardware.

At 605, the method may include detecting an error in a portion of a first memory die of a group of memory dies of the memory system, the group of memory dies including a plurality of first memory dies configured to store user data, one or more second memory dies configured to store parity information, and a third memory die. In some examples, aspects of the operations of 605 may be performed by an error detection component 425.

At 610, the method may include transmitting an indication of a reduced accessibility mode associated with the group of memory dies based on detecting the error. In some examples, aspects of the operations of 610 may be performed by an information transmission component 430.

At 615, the method may include reconstructing a first portion of user data associated with the portion of the first memory die in accordance with the reduced accessibility mode, where reconstructing the first portion of the user data is based on reading a second portion of the user data from portions of the plurality of first memory dies different from the first memory die and reading the parity information from the one or more second memory dies. In some examples, aspects of the operations of 615 may be performed by an error management component 435.

At 620, the method may include retiring the portion of the first memory die based on reconstructing the first portion of the user data. In some examples, aspects of the operations of 620 may be performed by a die management component 445.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:

Aspect 13: A method, apparatus, or non-transitory computer-readable medium including operations, features, circuitry, logic, means, or instructions, or any combination thereof for detecting an error in a portion of a first memory die of a group of memory dies of the memory system, the group of memory dies including a plurality of first memory dies configured to store user data, one or more second memory dies configured to store parity information, and a third memory die; transmitting an indication of a reduced accessibility mode associated with the group of memory dies based on detecting the error; reconstructing a first portion of user data associated with the portion of the first memory die in accordance with the reduced accessibility mode, where reconstructing the first portion of the user data is based on reading a second portion of the user data from portions of the plurality of first memory dies different from the first memory die and reading the parity information from the one or more second memory dies; and retiring the portion of the first memory die based on reconstructing the first portion of the user data.

It should be noted that the described techniques include possible implementations, and that the operations and the steps may be rearranged or otherwise modified and that other implementations are possible. Further, portions from two or more of the methods may be combined.

An apparatus is described. The following provides an overview of aspects of the apparatus as described herein:

Aspect 14: An apparatus (e.g., a memory system 110, a memory system controller 115), including: processing circuitry operable to couple with a group of memory dies including a plurality of first memory dies configured to store user data, one or more second memory dies configured to store parity information, and a third memory die, the processing circuitry configured to cause the apparatus to: detect an error at a first memory die of the plurality of first memory dies; transmit an indication of a reduced accessibility mode associated with the group of memory dies based on detection of the error; reconstruct a first portion of the user data associated with the first memory die in accordance with the reduced accessibility mode, where reconstruction of the first portion of the user data is based on reading of a second portion of the user data from the plurality of first memory dies different from the first memory die and reading of the parity information from the one or more second memory dies; and write the reconstructed first portion of the user data to the third memory die in accordance with the reduced accessibility mode.

An apparatus is described. The following provides an overview of aspects of the apparatus as described herein:

Aspect 15: A memory system (e.g., a memory system 110), including: a plurality of groups of memory dies (e.g., groups 210) each including a plurality of first memory dies (e.g., dies 205) configured to store user data, one or more second memory dies (e.g., die(s) 206) configured to store parity information, and a third memory die (e.g., a die 207); one or more data buses (e.g., bus(es) 215) coupled with the plurality of groups of memory dies and configured to transfer information between the plurality of groups of memory dies and a host system (e.g., a host system 105); and processing circuitry (e.g., a memory system controller 115) configured to cause the memory system to: transmit, from the memory system based on detection of an error in one or more groups of memory dies of the plurality of groups of memory dies, an indication of a reduced accessibility mode associated with the one or more groups of memory dies, where, in accordance with the reduced accessibility mode, at least one of the one or more data buses is not accessible by the host system; reconstruct a first portion of user data stored at one of the first memory dies of the one or more groups of memory dies, in accordance with the reduced accessibility mode, based on reading of a second portion of the user data stored at one or more others of the first memory dies of the one or more groups of memory dies and reading of parity information associated with the first memory die from one or more of the second memory dies of the one or more groups of memory dies; and write the reconstructed user data to one of the third memory dies of the one or more groups of memory dies in accordance with the reduced accessibility mode.

Aspect 16: The memory system of aspect 15, where each of the plurality of groups of memory dies corresponds to forty memory dies, of which the plurality of first memory dies are thirty-seven of the forty memory dies, the one or more second memory dies are two of the forty memory dies, and the third memory die is one of the forty memory dies.

Aspect 17: The memory system of any of aspects 15 through 16, where each of the plurality of first memory dies, the one or more second memory dies, and the third memory die is associated with the same capacity.

An apparatus is described. The following provides an overview of aspects of the apparatus as described herein:

Aspect 18: An apparatus, including: processing circuitry (e.g., of a memory system controller 115) operable to couple with a group of memory dies (e.g., a group 210) including a plurality of first memory dies (e.g., dies 205) configured to store user data, one or more second memory dies (e.g., die(s) 206) configured to store parity information, and a third memory die (e.g., a die 207), the processing circuitry configured to cause the apparatus to: detect an error in a portion of a first memory die of the plurality of first memory dies; transmit an indication of a reduced accessibility mode associated with the group of memory dies based on detection of the error; reconstruct a first portion of user data associated with the portion of the first memory die in accordance with the reduced accessibility mode, where the reconstruction of the first portion of the user data is based on reading of a second portion of the user data from portions of the plurality of first memory dies different from the first memory die and reading of the parity information from the one or more second memory dies; and retire the portion of the first memory die based on the reconstruction of the first portion of the user data.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOS), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor’s threshold voltage is applied to the transistor gate. The transistor may be “off” or “deactivated” if a voltage less than the transistor’s threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, instructions (e.g., code, software, firmware, logic) executed by a processing system (e.g., one or more processors, one or more controllers, control circuitry, processing circuitry, logic circuitry), or any combination thereof that is configured to cause a respective apparatus, device, or system to perform the described functions. If implemented as instructions executed by a processing system, the functions may be stored on or transmitted over as one or more instructions on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof, that are configured to cause the performance of the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus, comprising:
processing circuitry operable to couple with a group of memory dies comprising a plurality of first memory dies configured to store user data, one or more second memory dies configured to store parity information, and a third memory die, the processing circuitry configured to cause the apparatus to:
detect an error at a first memory die of the plurality of first memory dies;
transmit an indication of a reduced accessibility mode associated with the group of memory dies based on detection of the error;
reconstruct a first portion of the user data associated with the first memory die in accordance with the reduced accessibility mode, wherein reconstruction of the first portion of the user data is based on reading of a second portion of the user data from the plurality of first memory dies different from the first memory die and reading of the parity information from the one or more second memory dies; and
write the reconstructed first portion of the user data to the third memory die in accordance with the reduced accessibility mode.

2. The apparatus of claim 1, wherein, in accordance with the reduced accessibility mode, the processing circuitry is configured to cause one or more data buses associated with the group of memory dies to be inaccessible by a host system.

3. The apparatus of claim 1, wherein the processing circuitry is further configured to cause the apparatus to:
write second parity information to the one or more second memory dies based on writing the reconstructed first portion of the user data to the third memory die, the second parity information replacing a portion of the parity information.

4. The apparatus of claim 1, wherein the processing circuitry is further configured to cause the apparatus to:
transmit a second indication of an exit from the reduced accessibility mode associated with the group of memory dies based on writing the reconstructed first portion of the user data to the third memory die.

5. The apparatus of claim 1, wherein the first portion of the user data corresponds to all of the user data stored by the first memory die, and wherein the processing circuitry is further configured to cause the apparatus to:
retire the first memory die from further access operations after writing the reconstructed first portion of the user data to the third memory die.

6. The apparatus of claim 1, wherein the error corresponds to a first portion of the first memory die, and the first portion of the user data corresponds to some of the user data stored by the first portion of the first memory die, and wherein the processing circuitry is further configured to cause the apparatus to:
write the reconstructed first portion of the user data to a corresponding portion of the third memory die;
retire the first portion of the first memory die from further access operations after writing the reconstructed first portion of the user data to the corresponding portion of the third memory die; and
support the further access operations on a second portion of the first memory die after writing the reconstructed first portion of the user data to the corresponding portion of the third memory die.

7. The apparatus of claim 1, wherein, to indicate the reduced accessibility mode, the processing circuitry is configured to cause the apparatus to:
indicate that the reduced accessibility mode is associated with a first set of one or more groups of memory dies, comprising the group of memory dies, associated with a data bus.

8. The apparatus of claim 7, wherein the processing circuitry is further configured to cause the apparatus to:
operate a second set of one or more groups of memory dies, associated with a second data bus, in accordance with a baseline operating mode during operations of the second set of one or more groups of memory dies in accordance with the reduced accessibility mode.

9. The apparatus of claim 7, wherein each group of memory dies of the set of groups of memory dies corresponds to a respective rank of the apparatus.

10. The apparatus of claim 1, wherein the processing circuitry is further configured to cause the apparatus to:
detect a second error at a fourth memory die, of the plurality of first memory dies different from the first memory die and the third memory die; and
reconstruct a third portion of the user data associated with the fourth memory die based on reading a fourth portion of the user data, of the plurality of first memory dies and the third memory die different from the first memory die and the fourth memory die, and reading second parity information from the one or more second memory dies.

11. The apparatus of claim 1, wherein the group of memory dies corresponds to forty memory dies, of which the plurality of first memory dies are thirty-seven of the forty memory dies, the one or more second memory dies are two of the forty memory dies, and the third memory die is one of the forty memory dies.

12. The apparatus of claim 1, wherein each of the plurality of first memory dies, the one or more second memory dies, and the third memory die is associated with the same capacity.

13. A method by a memory system, comprising:
detecting an error at a first memory die of a group of memory dies of the memory system, the group of memory dies comprising: a plurality of first memory dies configured to store user data, one or more second memory dies configured to store parity information, and a third memory die;
transmitting an indication of a reduced accessibility mode associated with the group of memory dies based on detecting the error;
reconstructing a first portion of the user data associated with the first memory die in accordance with the reduced accessibility mode, wherein reconstructing the first portion of the user data is based on reading a second portion of the user data from the plurality of first memory dies different from the first memory die and reading the parity information from the one or more second memory dies; and
writing the reconstructed first portion of the user data to the third memory die in accordance with the reduced accessibility mode.

14. The method of claim 13, wherein, in accordance with the reduced accessibility mode, one or more data buses associated with the group of memory dies are not accessible by a host system.

15. The method of claim 13, further comprising:
writing second parity information to the one or more second memory dies based on writing the reconstructed first portion of the user data to the third memory die, the second parity information replacing a portion of the parity information.

16. The method of claim 13, further comprising:
transmitting a second indication of an exit from the reduced accessibility mode associated with the group of memory dies based on writing the reconstructed first portion of the user data to the third memory die.

17. The method of claim 13, wherein the first portion of the user data corresponds to all of the user data stored by the first memory die, the method further comprising:
retiring the first memory die from further access operations after writing the reconstructed first portion of the user data to the third memory die.

18. The method of claim 13, wherein the error corresponds to a first portion of the first memory die, and the first portion of the user data corresponds to some of the user data stored by the first portion of the first memory die, the method further comprising:
writing the reconstructed first portion of the user data to a corresponding portion of the third memory die;
retiring the first portion of the first memory die from further access operations after writing the reconstructed first portion of the user data to the corresponding portion of the third memory die; and
supporting further access operations on a second portion of the first memory die after writing the reconstructed first portion of the user data to the corresponding portion of the third memory die.

19. The method of claim 13, wherein the indication of the reduced accessibility mode comprises:
indicating that the reduced accessibility mode is associated with a first set of one or more groups of memory dies, comprising the group of memory dies, associated with a data bus.

20. The method of claim 19, further comprising:
operating a second set of one or more groups of memory dies, associated with a second data bus, in accordance with a baseline operating mode during operations of the second set of one or more groups of memory dies in accordance with the reduced accessibility mode.

21. The method of claim 19, wherein each group of memory dies of the second set of one or more groups of memory dies corresponds to a respective rank of the memory system.

22. The method of claim 13, further comprising:
detecting a second error at a fourth memory die, of the plurality of first memory dies different from the first memory die and the third memory die; and
reconstructing a third portion of the user data associated with the fourth memory die based on reading a fourth portion of the user data, of the plurality of first memory dies and the third memory die different from the first memory die and the fourth memory die, and reading second parity information from the one or more second memory dies.

23. The method of claim 13, wherein the group of memory dies corresponds to forty memory dies, of which the plurality of first memory dies are thirty-seven of the forty memory dies, the one or more second memory dies are two of the forty memory dies, and the third memory die is one of the forty memory dies.

24. The method of claim 13, wherein each of the plurality of first memory dies, the one or more second memory dies, and the third memory die is associated with the same capacity.

25. A memory system, comprising:
a plurality of groups of memory dies each comprising a plurality of first memory dies configured to store user data, one or more second memory dies configured to store parity information, and a third memory die;
one or more data buses coupled with the plurality of groups of memory dies and configured to transfer information between the plurality of groups of memory dies and a host system; and
processing circuitry configured to cause the memory system to:
transmit, from the memory system based on detection of an error in one or more groups of memory dies of the plurality of groups of memory dies, an indication of a reduced accessibility mode associated with the one or more groups of memory dies, wherein, in accordance with the reduced accessibility mode, at least one of the one or more data buses is not accessible by the host system;
reconstruct a first portion of the user data stored at one of the plurality of first memory dies of the one or more groups of memory dies, in accordance with the reduced accessibility mode, based on reading of a second portion of the user data stored at one or more others of the plurality of first memory dies of the one or more groups of memory dies and reading of the parity information associated with a first memory die from the one or more second memory dies of the one or more groups of memory dies; and
write the reconstructed user data to the third memory die of the one or more groups of memory dies in accordance with the reduced accessibility mode.

26. The memory system of claim 25, wherein each of the plurality of groups of memory dies corresponds to forty memory dies, of which the plurality of first memory dies are thirty-seven of the forty memory dies, the one or more second memory dies are two of the forty memory dies, and the third memory die is one of the forty memory dies.

27. The memory system of claim 25, wherein each of the plurality of first memory dies, the one or more second memory dies, and the third memory die is associated with the same capacity.

28. A method by a memory system, comprising:
detecting an error in a portion of a first memory die of a group of memory dies of the memory system, the group of memory dies comprising a plurality of first memory dies configured to store user data, one or more second memory dies configured to store parity information, and a third memory die;
transmitting an indication of a reduced accessibility mode associated with the group of memory dies based on detecting the error;
reconstructing a first portion of the user data associated with the portion of the first memory die in accordance with the reduced accessibility mode, wherein reconstructing the first portion of the user data is based on reading a second portion of the user data from portions of the plurality of first memory dies different from the first memory die and reading the parity information from the one or more second memory dies; and
retiring the portion of the first memory die based on reconstructing the first portion of the user data.

29. The method of claim 28, further comprising:
writing the reconstructed first portion of the user data to the third memory die in accordance with the reduced accessibility mode, wherein retiring the portion of the first memory die is based on writing the reconstructed first portion of the user data.

30. An apparatus, comprising:
processing circuitry operable to couple with a group of memory dies comprising a plurality of first memory dies configured to store user data, one or more second memory dies configured to store parity information, and a third memory die, the processing circuitry configured to cause the apparatus to:
detect an error in a portion of a first memory die of the plurality of first memory dies;
transmit an indication of a reduced accessibility mode associated with the group of memory dies based on detection of the error;
reconstruct a first portion of the user data associated with the portion of the first memory die in accordance with the reduced accessibility mode, wherein the reconstruction of the first portion of the user data is based on reading of a second portion of the user data from portions of the plurality of first memory dies different from the first memory die and reading of the parity information from the one or more second memory dies; and
retire the portion of the first memory die based on the reconstruction of the first portion of the user data.
